(19) United States
(12) Patent Application Publication
(10) Pub. No.: US 2014/0304015 A1
(43) Pub. Date: Oct. 9, 2014

(54) APPARATUS AND METHOD FOR MANAGING ACCESS TO A RESOURCE

(71) Applicant: JEFF MCMANUS LTD., Buckinghamshire (GB)

(72) Inventor: Jeff McManus, Buckinghamshire (GB)

(21) Appl. No.: 14/356,009

(22) PCT Filed: Oct. 29, 2012
(86) PCT No.: PCT/EP2012/071392

§ 371 Date: May 2, 2014

Related U.S. Application Data
(60) Provisional application No. 61/555,537, filed on Nov. 4, 2011.
(60) Provisional application No. 61/614,117, filed on Mar. 22, 2012.

(51) Int. Cl. G06Q 10/02

(52) U.S. Cl. CPC G06Q 10/02
USPC 705/5

(57) ABSTRACT

There is provided a resource access management system for managing user access to a resource having a number of resource slots, wherein each resource slot can be used by a user. The resource access management system comprises a standard access configured to allow users to access the resource, and a queue-less access configured to allow users that have a valid authorisation to access the resource. The resource access management system is configured, for each occurrence of the resource, to make a portion of the resource slots available for allocation to users that access the resource using the queue-less access, to make at least the remaining resource slots available for use by users that access the resource using the standard access, and to ensure that a number of authorisations issued for an occurrence of the resource does not exceed the number of allocable resource slots.

### TECHNICAL FIELD

The present invention relates to an apparatus and a method for managing access to a resource.

### BACKGROUND

There are many situations in which the number of users that wish to access a resource increases at a rate that exceeds the rate at which the users are able to access that resource, such that there is an accumulation of users that are waiting to access that resource. By way of example, queues often form when people wish to attend a show or event, board a bus, coach or train, gain entry to a location of interest, make transactions at a bank, make a journey on an aeroplane or ride an attraction at a theme park. Similarly, people also often have to wait to use equipment in a gym or to get a table in a restaurant. The longer that users have to spend waiting to access a resource, the more dissatisfied they will be with their experience, and the greater the likelihood that they will choose not to visit or attempt to access that resource in the future. Furthermore, it will often be the case that whilst the users queue for a first resource they will be unable to access any other resources, nor will they be able to perform other actions that could otherwise be of benefit to the resource provider. For example, whilst a user is queuing to try on clothing in the changing rooms of a department store, they will have only very limited opportunity to view or peruse other items that they may be interested in purchasing, which can therefore limit the revenue generated for the store.

As a way of offering an improved user experience, and of increasing revenue, some resource providers allow user's to pay an additional charge in order to minimise the time they spend queuing to access a resource. For example, a large proportion of theme parks now offer visitors the option of paying an additional fee to make use of a “fast track” or “express” access for one or more attractions, which they suggest minimises the time that their visitors must wait, by allowing them to gain entry to the attraction via a separate entrance reserved for those who have paid the additional fee. In addition, some resource providers allow users to make use of virtual queuing, in which users are allocated a place in a virtual queue that is implemented on a computer. The virtual queuing system can then indicate to the user when they should attempt to access the resource based on an estimate of the time at which it is suggested that they will be approaching the front of the virtual queue. For example, such a virtual queuing system can operate in parallel to a standard physical queue, and will therefore be configured to cause a wait of the same length of time as the physical queue. Towards the end of the wait in the virtual queue, the virtual queuing system will notify a user of the virtual queue that they should attempt to access the resource. Typically, a user will be required to pay a fee in order to make use of virtual queuing.

One problem with these methods for managing user access to a resource is that they still require users to spend at least some time waiting in a physical queue, which on a busy day can be very long. For example, whilst the number of user's using a “fast track” or “express” access should ideally be less than the number using a standard access (i.e. the access for those who have not paid for fast track access), there will almost always be at least a small queue of users using the fast track access. For virtual queuing systems, in order to ensure that the utilisation of a resource is maximised, such a virtual queuing system must be configured to ensure that there is a sufficient number of users present at the resource on each occasion that the resource becomes available. The only way to achieve this is to provide the users with an early indication of the time at which users will be approaching the front of the virtual queue, such that the users have more than enough time to reach the resource before they are actually due to reach the front of the queue. Consequently, resource providers/operators are required to provide a separate queue/waiting area for users of these fast track/virtual queuing systems, as well as a standard access queue/waiting area, which therefore consumes space and incurs a cost to install, operate and maintain. In addition, even if users spend only a small amount of time in a queue, this still impacts on the amount of time that these users can spend generating revenue for the resource provider via other revenue streams.

Furthermore, as these methods still require at least some time in a queue, it is still possible that users will be dissatisfied with their experience. For example, if a significant number of users decide to make use of a “fast track” or “express” access at approximately the same time, i.e. they bunch/cluster together in large numbers, then the number of users in queuing for the “fast track” or “express” access can potentially grow to the point where the length of the queue is close to, or even exceeds, the length of the queue for the standard access. This will likely discourage users from paying the additional charge for the “fast track” or “express” access, and potentially cause frustration to those users who may have already paid to use the “fast track” or “express” access before they were aware of the relatively high level of demand. By way of further example, as virtual queuing systems rely on an estimate of the time at which users will be approaching the front of the virtual queue, if this estimate is even slightly too short, or the timing of the indication to the user is even slightly too early, then the number of user's in the actual queue can potentially grow to the point where users are unhappy with the length of the time that they are required to wait. Moreover, if the estimate is even slightly too long, or the timing of the indication to the user are even slightly too late, then there will not be enough users present at the resource on each occasion that the resource becomes available to maximise the available capacity. Consequently, such methods for managing user access to a resource do not ensure that use of the available capacity of a resource is maximised/optimised, do not always lead to an improved user experience, and do not optimise the revenue opportunities for the resource provider. Moreover, with conventional resource access management methods, if significant bunching/clustering does take place at a “fast track” or “express” access, then this can only be reduced by allowing the users in the “fast track” or “express” access to access the resource in increased, if not continuous, preference to those users that are queuing to use the standard access, which can cause significant dismay and anger to the users queuing to use the standard access.

### SUMMARY

It is therefore an object of the present invention to provide a system and method for managing user access to a resource in which at least a portion of the users that wish to access a resource can do so without having to spend any time at all in a queue.

According to a first aspect there is provided a resource access management system for managing user access to a resource having a number of resource slots, wherein each resource slot can be used by a user. The resource access management system comprises a standard access configured to allow users to access the resource, a standard access queue enclosure through which users must pass to reach the standard access, and a queue-less access configured to allow users that have a valid authorisation to access the resource. The resource access management system is configured, for each occurrence of the resource, to make a portion of the resource slots available for allocation to users that access the resource using the queue-less access, to make at least the remaining resource slots available for use by users that access the resource using the standard access, and to ensure that a number of authorisations issued for an occurrence of the resource does not exceed the number of allocable resource slots.

The standard access and the queue-less access can be configured to transition between a locked and an unlocked state so as to control user to access the resource. The standard access and the queue-less access can be configured to allow users to access the resource in a particular order.

The queue-less access can be configured to only allow an authorised user to access an occurrence of the resource. The resource access management system may then further comprise an authorisation issuer configured to provide a user with an authorisation to access an occurrence of the resource using the queue-less access, and an authorisation verifier configured to determine if a user has a valid authorisation to access the resource using the queue-less access and to control the queue-less access accordingly.

The resource access management system may further comprise a resource access manager that is communicatively connected to any of the standard access and the queue-less access. The resource access manager may then be configured to communicate with the authorisation issuer in order to control the issue of authorisations, thereby controlling access to the resource using the queue-less access.

The resource access manager can be configured to determine a frequency of occurrence of the resource, and to use the determined frequency of occurrence of the resource to determine when authorisations to use the queue-less access should be issued. The resource access manager may then configured to instruct the authorisation issuer to only issue authorisations that allow use of the queue-less access at a predicted time of each occurrence of the resource.

The resource access management system may further comprise a standard access queue entrance, through which a user must pass in order to enter the standard access queue enclosure. The standard access queue entrance may then be configured to identify a user that enters the standard access queue enclosure and to notify the resource access manager accordingly, and the standard access configured to identify a user that exits the standard access queue enclosure and to notify the resource access manager accordingly. The resource access manager may then be configured to use the notifications received from the standard access queue entrance and the standard access to determine number of users in the standard access queue enclosure and to determine the length of time that each user spends in the standard access queue enclosure.

The resource access manager can be configured to estimate a waiting time for a user who was to presently enter the standard access queue enclosure based on any of the determined number of users in the standard access queue enclosure and the determined the length of time that each user spends in the standard access queue enclosure.

The authorisation issuer can be configured to only provide a user with an authorisation to access an occurrence of the resource using the queue-less access upon acceptance of an associated charge. The resource access manager can be configured to determine a charge that a user is required to accept in proportion to estimated waiting time for a user who was to presently enter the standard access queue enclosure.

According to a second aspect there is provided a method for managing user access to a resource having a number of resource slots, wherein each resource slot can be used by a user. The method comprises, for each occurrence of the resource, making a portion of the resource slots available for allocation to users that access the resource using a queue-less access, and making at least the remaining resource slots available for use by users that access the resource using a standard access, wherein to reach the standard access users must pass through a standard access queue enclosure. The method also comprises allowing users to access the resource using the queue-less access provided that they have a valid authorisation, wherein the number of authorisations issued for each occurrence of the resource will not exceed the number of allocable resource slots.

The method may further comprise determining a frequency of occurrence of the resource, and using the determined frequency of occurrence of the resource to determine when authorisations to use the queue-less access should be issued. Optionally, the authorisations issued will only allow use of the queue-less access at a predicted time of each occurrence of the resource.

The method may further comprise identifying a user that enters the standard access queue enclosure and identifying a user that exits the standard access queue enclosure, and thereby determining the number of users in the standard access queue enclosure and the length of time that each user spends in the standard access queue enclosure. The method may then further comprise estimating a waiting time for a user who was to presently enter the standard access queue enclosure based on any of the determined number of users in the standard access queue enclosure and the determined the length of time that each user spends in the standard access queue enclosure.

The method may comprise only providing a user with an authorisation to access an occurrence of the resource using the queue-less access upon acceptance of an associated charge. The method may then further comprise determining a charge that a user is required to accept in proportion to the estimated waiting time for a user who was to presently enter the standard access queue enclosure.

### BRIEF DESCRIPTION OF THE DRAWINGS

Some embodiments of the present invention will now be described in detail with reference to the accompanying drawings, in which:

FIG. 1 illustrates schematically an example of a resource access management system suitable for managing user access to a resource in accordance with the methods described herein; and

FIG. 2 is a flow diagram illustrating an example of a process for managing user access to a resource in accordance with the methods described herein.

### DETAILED DESCRIPTION

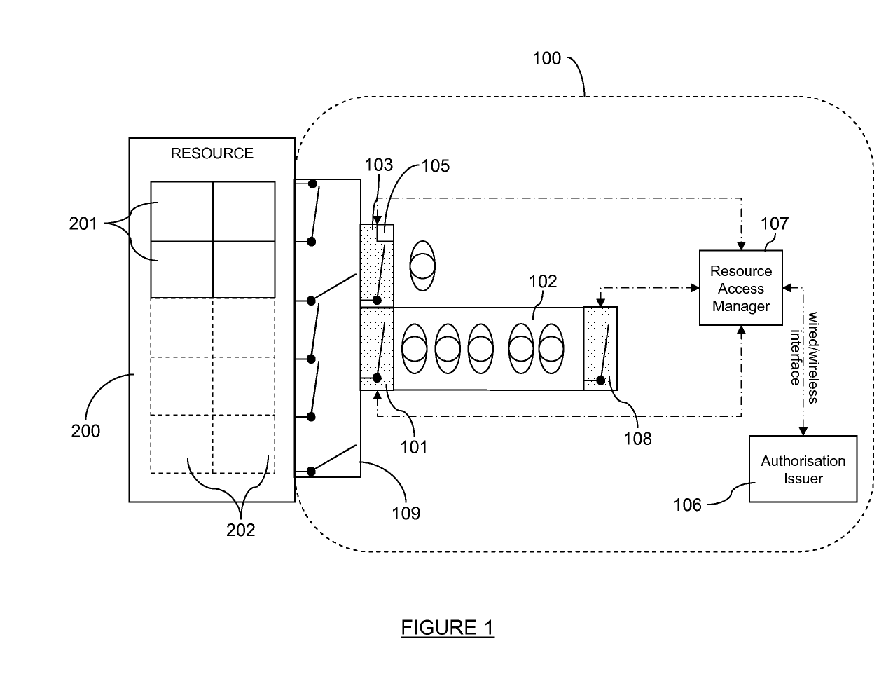

In order to at least mitigate the problems outlined above, it is proposed here to provide a resource access management system that ensures that at least a proportion of the user's that wish to access a resource can do so without having to spend time in a queue. FIG. 1 illustrates schematically an example of such a resource access management system 100 suitable for managing user access to a resource 200. The system 100 comprises a standard access 101 (e.g. that can be used without acceptance of an associated charge) and a standard access queue enclosure 102 through which users must pass to reach/access the resource 200 via the standard access 101. The standard access queue enclosure 102 therefore provides an area in which users wishing to access the resource 200 via the standard access 101 can queue/wait. The system 100 further comprises a queue-less access 103 through which users can access the resource 200 provided they have a valid authorisation to do so. Both the standard access 101 and the queue-less access 103 are controlled. For example, one or both of the standard access 101 and the queue-less access 103 can be comprise a turnstile or gate arrangement that can transition between a locked and an unlocked state so as to only allow users to access the resource 200 in appropriate circumstances and/or when a user has met some criteria for access.

The resource 200 has a number of resource slots/positions/spaces/seats/groups of seats available that can be used by users for each occurrence of the resource. The system 100 is configured such that a portion of these resource slots are at least initially available to be allocated for use by users that access the resource using the queue-less access 103, and are therefore referred to as allocable or reservable resource slots 201 (indicated by solid boxes in FIG. 1). The remaining resource slots are at least initially available for use by the users that access the resource using the standard access 101, and are therefore referred to as non-allocable or non-reservable resource slots 202 (indicated by dashed boxes in FIG. 1). Therefore, for each occurrence of the resource 200, the queue-less access 103 enables users that have a valid authorisation to access the resource 200 (i.e. without having to queue), wherein the number of users that have a valid authorisation will not exceed the number of allocable resource slots 201. The standard access 101 enables users in the standard access queue enclosure 102 to access the resource 200 on a first come, first served (FCFS) basis, wherein the number of users that will be allowed to access an occurrence of the resource 200 using the standard access 101 will be at least equal to the number of non-allocable resource slots 202. The system 100 could be configured to allow user's accessing the resource 200 using the standard access 101 to make use of any unallocated/unreserved allocable resource slots 201 (i.e. any allocable resource slots 201 that are not allocated to user's of the queue-less access 103) as well as the non-allocable resource slots 202. This would ensure that utilisation of the resource 200 is maximised for each occurrence of the resource 200.

Optionally, the system 100 can be configured such that standard access 101 and the queue-less access 103 are controllable so as to allow users to access the resource in a particular order. For example, the system 100 could be configured such that, when the resource 200 becomes available for a particular occurrence, the queue-less access 103 allows user's that have a valid authorisation to access the resource, prior to allowing the user's in the standard access queue enclosure 102 to access the resource on first come, first served basis. This would be particularly useful in order to allow the users of the queue-less access 103 to access a specifically allocated resource slot, or in order to provide users of the queue-less access 103 with the opportunity to preferentially select the resource slot of their choice.

In order to determine if a user has a valid authorisation to access the resource 200 using the queue-less access 103, the queue-less access 103 can be provided with an authorisation verifier 105. The authorisation verifier 105 would be configured to validate the user's right to access a particular occurrence of the resource 200 using the queue-less access 103, and to control the queue-less access 103 accordingly. To do so, the authorisation verifier 105 would be configured with an interface that enables it to accept or collect authorisation information from a user, and to process this authorisation information in order to determine if it is associated with a valid authorisation to access a particular occurrence of the resource 200.

The system 100 will therefore also typically comprise an authorisation issuer 106 configured to provide user's with an authorisation to access a particular occurrence of the resource 200 using the queue-less access 103. In this regard, a user will normally only be provided with an authorisation to access a particular occurrence of the resource 200 using the queue-less access 103 upon acceptance of an associated charge. For example, the authorisation issuer 106 could comprise a computer device having a user interface through which users can interact with the authorisation issuer 106. The authorisation issuer 106 would thereby indicate to users a charge associated with accessing one or several alternative occurrences of the resource 200 using the queue-less access 103, allow users to select a particular occurrence of the resource 200 and to accept the associated charge. The authorisation issuer 106 would then be configured to provide the user within some authorisation information that can be used by the authorisation verifier 105 to confirm that the user has a valid authorisation, or to associate some user identification data with authorisation information (i.e. relating to the particular occurrence of the resource 200 for which the user has been authorised to use the queue-less access 103) and to enable the authorisation verifier 105 to access this authorisation information. The authorisation issuer 106 could be configured to allow users to accept an associated charge using any of a number of forms of payment, such as cash, credit or debit cards, tokens, vouchers, contactless payment, transfers etc.

According to a first example, the authorisation issuer 106 could be configured to issue an access token, in the form of a physical or electronic ticket or voucher, to a user that has obtained an authorisation to use the queue-less access 103 to access a particular occurrence of the resource 200 (e.g. who has accepted a charge associated with using the queue-less access 103). Authorisation information relating to the particular occurrence of the resource 200 for which the user has been authorised to use the queue-less access 103 would be encoded onto or associated with the token. The user would then present this token to the authorisation verifier 105. The authorisation verifier 105 would be configured to scan/read the token (e.g. using a barcode, a bokode, a QR code, programmable RFID, Bluetooth, near field communication (NFC) etc) to determine the user's authorisation information, and would only allow the user to use the queue-less access 103 at the time of the particular occurrence of the resource 200 that the user has been authorised to access the resource (i.e. in accordance with the authorisation information determined from the analysis/interrogation of the access token). Typically, the authorisation issuer 106 would be configured to issue an access token that the authorisation verifier 105 would only determine to be valid for a single user and a single occurrence of the resource. However, if desired, the authorisation verifier 105 could be configured to retain, destroy or otherwise modify the access token so as to prevent its valid use to access any further occurrence of the resource for which the user has not obtained an authorisation. For example, if the access token was provided electronically, then the authorisation verifier 105 could be configured to the valid authorisation information associated with this access token from the system memory so as to preclude a second use of this access token for this resource.

According to a second example, the authorisation issuer 106 could be configured to issue an access token, in the form of an access code, to a user that has obtained an authorisation to use the queue-less access 103 to access a particular occurrence of the resource 200. This access code could be manually recorded by the user, or could comprise electronic information transmitted to a portable computer device or other recognisable article carried or worn by or part of the user. Authorisation information relating to the particular occurrence of the resource 200 for which the user has been authorised to use the queue-less access 103 would be encoded within or associated with the access code. The user would then provide this access code to the authorisation verifier 105 (e.g. by manually inputting or electronically transmitting the access code etc). The authorisation verifier 105 would be configured to determine the authorisation information using the access code, and would only allow the user to use the queue-less access 103 at the time of the particular occurrence of the resource 200 that the user has been authorised to access the resource (i.e. in accordance with the authorisation information determined from the access code). Typically, the authorisation issuer 106 would be configured to issue an access code that the authorisation verifier 105 would only determine to be valid for a single user and a single occurrence of the resource.

According to a third example, the authorisation issuer 106 could be configured to obtain biometric data from a user that has obtained an authorisation to use the queue-less access 103 to access a particular occurrence of the resource 200. This biometric data can then be stored in association with authorisation information relating to the particular occurrence of the resource 200 for which the user has been authorised to use the queue-less access 103. The user would then present themselves to the authorisation verifier 105, and the authorisation verifier 105 would be configured to obtain corresponding biometric data from the user. The authorisation verifier 105 would be configured to use the obtained biometric data to determine the user's authorisation information, and would only allow the user to use the queue-less access 103 at the time of the particular occurrence of the resource 200 that the user has been authorised to access the resource (i.e. in accordance with the authorisation information determined from the biometric data). Typically, the authorisation issuer 106 would be configured to associate authorisation information with biometric data that the authorisation verifier 105 would only determine to be valid for a single user and a single occurrence of the resource.

The system 100 can optionally comprise a resource access manager 107 that is communicatively connected to one or both of the standard access 101 and the queue-less access 103. The connections between the resource access manager 107 and one or both of the standard access 101 and the queue-less access 103 allows the resource access manager 107 to obtain information from each access, and to send information and/or instructions to each access.

For example, this would enable one or both of the standard access 101 and the queue-less access 103 to communicate with the resource access manager 107 such that the resource access manager 107 is aware of the number of users that access the resource 200 using each access. For example, one or both of the standard access 101 and the queue-less access 103 can communicate with the resource access manager 107 each time the access is used by a user to access the resource 200 such that the resource access manager 107 can provide a register. Alternatively, one or both of the standard access 101 and the queue-less access 103 can be provided with or connected to a register (not shown) or other means for determining when a user passes through the access to count and/or record the number of user's that have passed through the access. Preferably, one or both of the standard access 101 and the queue-less access 103 would be able to identify each individual that makes use of the standard access 101 and the queue-less access 103 respectively. One or both of the standard access 101 and the queue-less access 103 could then send occasional reports to the resource access manager 107, each report providing information regarding the user's that have accessed the resource 200 since the last report sent by that access. Through communication with both the standard access 101 and the queue-less access 103, the resource access manager 107 can be configured to monitor the usage levels of each access. This information can then be used by a system administrator to adjust the system configuration if so desired.

The resource access manager 107 could also be communicatively connected to one or both of the authorisation verifier 105 and the authorisation issuer 106 via either of a wired interface or a wireless interface (illustrated by the dot-dash lines in FIG. 1). Through communication with the standard access 101, the queue-less access 103 and the authorisation issuer 106, the resource access manager 107 could be configured to control the issue of authorisations by the authorisation issuer 106, and to thereby control access to the resource using the queue-less access 103. For example, the resource access manager 107 could be configured to control the standard access 101 and the queue-less access 103 so as to allow users to access the resource in a particular order (as described above), by only allowing access to the resource 200 using the standard access 101 when the authorisation verifier 105 has informed the resource access manager 107 that all of authorisations issued for a particular occurrence of the resource 200 have been used to access the resource 200 using the queue-less access 103. By way of further example, the resource access manager 107 could be configured to monitor the level of demand for access to the resource 200 using one or both of the standard access 101 and the queue-less access 103, and to automatically adjust the associated charge (i.e. levied by the authorisation issuer 106) for using the queue-less access 103 in dependence upon the monitored level of demand for access to the resource 200.

In addition, in order to minimise the possibility that a queue will form at the queue-less access 103, the resource access manager 107 could be configured to measure and/or estimate the frequency of occurrence of the resource 200, and use the measured and/or estimated frequency of occurrence of the resource 200 to determine the frequency with which authorisations to use the queue-less access 103 should be issued. For example, the resource 200 could be configured to measure the times at which/period with which it becomes available (i.e. by using of one or more sensors (not shown)), and to report this directly or indirectly to the resource access manager 107. The resource access manager 107 can then use the periods/times measured by the resource 200 to determine the frequency with which authorisations to use the queue-less access 103 should be issued by the authorisation issuer 106. By way of example, the resource access manager 107 could be configured to determine/estimate that the frequency of occurrence of resource 200 is equal to the most recently measured period/times, or an average of a number of measured period/times etc, and thereby determine/estimate the time at which future occurrences of the resource 200 will take place. The resource access manager 107 would then instruct the authorisation issuer 106 to only issue authorisations that allow use of the queue-less access 103 at the predicted times of occurrence of the resource 200.

Moreover, if it is desired that the resource access manager 107 monitor the level of demand for access to the resource 200, then the system can further comprise a standard access queue entrance 108, through which users must pass in order to enter the standard access queue enclosure 102 and thereby join the queue for the standard access 101. This standard access queue entrance 108 can also be provided with or connected to a register (not shown) or other means for determining when a user passes through the entrance to count and/or record the number of users that have passed through the entrance. For example, the standard access queue entrance 108 can be provided by a turnstile or gate arrangement that is communicatively connected to the resource access manager 107. Preferably, the standard access queue entrance 108 will also be able to identify each individual that enters the standard access queue enclosure 102 through standard access queue entrance 108. The resource access manager 107 can therefore communicate with the standard access queue entrance 108 to obtain information regarding the users that have joined the queue. The resource access manager 107 can then use this information, in combination with the information received from the standard access 101, to determine the number of users currently in the queue, and thereby determine the level of demand for the access to the resource 200. For example, a measure of the level of demand could be determined as the estimated time it will take a user who joins the queue to obtain access to the resource 200 (e.g. the time a user joining the back of the queue will have to wait). This could be based on one or both of the rate of arrival of users through the standard access queue entrance 108 and the number of users who have been issued with authorisations to contemporarily access the resource 200 through queue-less access 103.

As outlined above, it is preferable that the standard access queue entrance 108 will be configured to identify an individual that enters the standard access queue enclosure 102. Similarly, the standard access 101 would then be configured to identify an individual that exits the standard access queue enclosure 102. For example, the standard access queue entrance 108 and the standard access 101 can identify a user that passes through by scanning/reading an access token carried by the user (e.g. using a barcode, a bokode, a QR code, programmable RFID, Bluetooth, near field communication (NFC) etc), using biometric scanning, etc. The standard access queue entrance 108 and the standard access 101 can then be configured to report this information to the resource access manager 107.

By identifying an individual user as they enter and exit the standard access queue enclosure 102, and notifying the resource access manager 107 accordingly, this enables the resource access manager to accurately determine number of users that are queuing/waiting in the standard access queue enclosure 102 and to determine the length of time that each user spends in the standard access queue enclosure 102. This information can then be used to accurately estimate the current waiting time for a user who was to presently enter the standard access queue enclosure 102. This estimate will have significantly better accuracy than waiting times estimates provided be conventional resource access systems, which typically rely on a visual assessment of the physical length of the queue by the operator. The estimated waiting time can then be displayed to users, and can also be used when determining the charge associated with using the queue-less access 103.

The resource access management system 100 described above therefore also makes it possible for the charge that the user is required to accept to be determined in proportion to the predicted or calculated reduction in the time that the user is required to wait, such that the lower the reduction in the waiting time that is provided by the option of using the queue-less access 103 for a particular occurrence of the resource 200, the lower the charge to the user. By way of further example, this also makes it possible for the charge that the user is required to accept to be determined in proportion to the number of or rate at which users are making use of the resource access management system 100 to obtain access to an allocable resource slot 201 for a particular occurrence of the resource 200. In addition, this also makes it possible for the charge that the user is required to accept to be determined based on the specific particular occurrence of the resource 200 which the user chooses. For example, if a user wishes to access an occurrence of the resource 200 at a time in the very near/immediate future, then the charge for reserving access for this occurrence can be determined to be higher than if the user is prepared to wait until later to access the resource. Additionally, the calculation of the charge that is required to be accepted can also take into account factors that are based on historical booking data (e.g. so as to take account of the impact of the time of day, the day of the week, public holidays etc) and contemporary parameters (e.g. such as the current weather etc. This information could be input to system manually, or collected automatically by the system.

Of course, the charge can be determined based on any one of, or a combination of any of these factors. This system 100 therefore also provides for increased flexibility in the charging mechanisms available to the resource provider, which in turn can increase the likelihood that users wishing to access the resource will accept the charge for using the queue-less access 103 to access a particular occurrence of the resource 200, even when the levels of demand for the resource are relatively low, as the charge for doing so will also be relatively low. This system 100 for managing user access to a resource therefore leads to a further improved user experience, and further optimises the revenue opportunities for the resource provider.

The resource access management system 100 may also comprise a single resource access manager 107 managing access to multiple resources, wherein each resource will be provided with a standard access 101 and a queue-less access 103. The resource access management system 100 can then be configured to provide that the charge for accessing an occurrence of a first resource is different to that for accessing an occurrence of a second resource. For example, the system could be configured to provide that the charge for using a queue-less access to access the most popular and/or expensive to run resources is greater than the charge for using a queue-less access to access those resources that are less popular and/or less expensive to run. This also provides the resource access management system 100 with another means for managing access to a resource. For example, this provides that the resource access management system 100 can determine that the charge for accessing an occurrence of a resource that is preferable to the resource provider will be lower than that for accessing an occurrence of the resource that is not preferable to the resource provider, e.g. during the lunch hour, so as to encourage users to access the resource at the time preferred by the resource provider. Of course, the charge can be determined based on any one of, or a combination of any of the factors outlined above.

The resource access management system 100 may optionally comprise a resource slot allocation system 109. This resource slot allocation system 109 would be located between the standard access 101 and the queue-less access 103 and would be configured to control which resource slots of the resource 200 can be accessed by the users of both the standard access 101 and the queue-less access 103. For example, the resource slot allocation system 109 could be configured to only allow access to one or more preferred resource slot(s) of the resource 200 to those user's of the queue-less access 103 that are authorised to use those preferred slot(s). The resource slot allocation system 109 would therefore prevent any unauthorised users from accessing those preferred slots, and would only allow unauthorised users to access the remaining slots. By way of further example, as illustrated in FIG. 1, the resource access management system 100 could be provided by a gating arrangement that cooperates with and/or is controlled by the resource access management system 100 and/or the authorisation verifier 105 so as to regulate which of the resource slots can be accessed by the users. However, the resource slot allocation system 109 could be provided by any suitable gating arrangement or configurable structure and is not limited to the illustrated embodiment.

In addition, depending upon the type of resource(s) for which the resource access management system 100 is used, the resource access management system 100 could be configured with more than one queue-less access through which the resource can be accessed. For example, each queue-less access that can be used to access a resource can relate to a different segment or subset of the allocable resource slots (e.g. for seats at the front or back of a rollercoaster ride, or different areas of a theatre, cinema or other viewing attraction). The authorisation issuer 106 would then be configured to issue authorisations for a particular occurrence of a resource that only allows access to the resource through an associated queue-less access. For example, the charge associated with using a first queue-less access to access a first subset of the allocable resource slots for an occurrence of a resource could then be configured to be greater than the charge associated with using a second queue-less access to access a second subset of the allocable resource slots for the same occurrence of the resource. For example, the authorisation issuer 106 and the authorisation verifier 105 of each queue-less access could be configured such that the authorisation verifier 105 could identify a specific allocable resource slot that has been allocated to the user, and to allow the user to use the queue-less access via which the user can access the identified allocable resource slot.

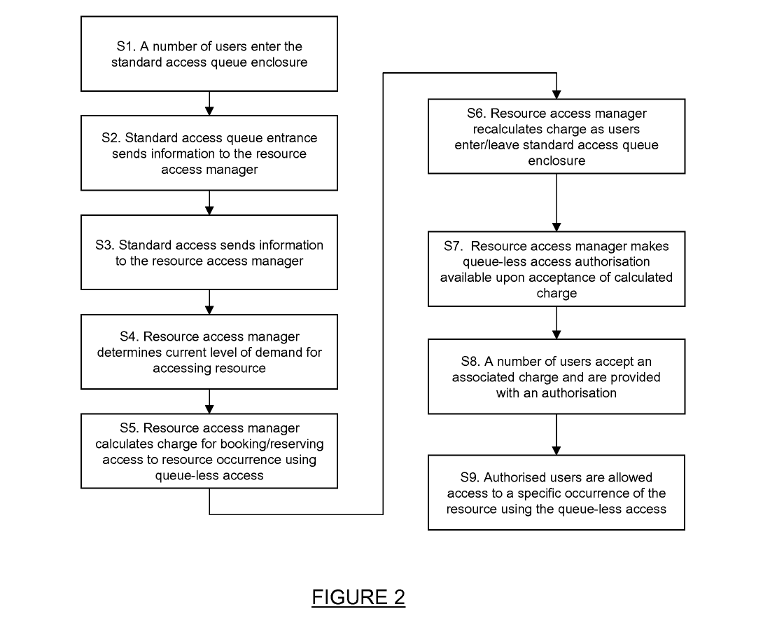

FIG. 2 is a flow diagram illustrating an example of the process for managing user access to a resource as outlined above. The steps performed are as follows:
S1. A number of users wishing to access the resource using the standard access 101 attempt to do so by entering through the standard access queue entrance 108, and form a queue of uses waiting in the standard access queue enclosure 102.
S2. The standard access queue entrance 108 sends information to the resource access manager 107 that allows the resource access manager 107 to determine the number of users that have entered the standard access queue enclosure 102. For example, this may involve reporting to the resource access manager 107 each time a user passes through the standard access queue entrance 108, or may involve sending regular/periodic reports to the resource access manager 107, each report identifying the users that have entered the standard access queue enclosure 102 since the last report, and the time at which they entered.
S3. Similarly, the standard access 101 sends information to the resource access manager 107 that allows the resource access manager 107 to determine the number of users that have left/exited the standard access queue enclosure 102. For example, this may involve reporting to the resource access manager 107 each time a user passes through the standard access 101, or may involve sending regular/periodic reports to the resource access manager 107, each report identifying the users that have exited the standard access queue enclosure 102 since the last report, and the time at which they left.
S4. The resource access manager 107 can then determine the number of users in the standard access queue enclosure 102, and the length of time each user spends waiting in the standard access queue enclosure 102, based on the information provided by the standard access entrance 108 and standard access 101, and thus will be able to accurately estimate the current waiting time for a user who was to presently enter the standard access queue enclosure 102. The resource access manager 107 then uses this estimate of the standard access waiting time to establish the current the level of demand for the resource 200.
S5. Based on the level of demand for the resource 200, the resource access manager 107 calculates a charge that must be accepted by a user that wishes to make use of the resource access management system to book/reserve access to the resource at a specific time via the queue-less access 103. For example, this charge can be proportional to the reduction in the time that the user would have been required to wait to access the resource 200 if they had made use of the standard access 101 rather than the queue-less access 103. In addition, or alternatively, this charge can be proportional to the rate at which users are making use of the booking/reservation system to access a specific occurrence of the resource 200 via the queue-less access 103. Of course, the charge can be determined based on any one of, or a combination of any of the factors described herein.
S6. As the number of users in the standard access queue enclosure 102 changes (e.g. due to the change in the rate of users joining and/or leaving the standard access queue enclosure 102), such that the waiting time in the standard access queue enclosure 102 changes, the resource access manager 107 can modify the established current level of demand, and can modify/recalculate the charge for accessing the resource 200 using the queue-less access 103 accordingly.
S7. The resource access manager 107 then offers users the opportunity to book/reserve access to a specific occurrence of the resource 200 using the queue-less access 103 upon acceptance of the calculated charge. For example, the resource access manager 107 can be connected to one or more authorisation issuers 106 that are distributed around the location in which the resource 200 can be found, and each of the one or more authorisation issuers 106 enable users to view and accept the required charge, and can provide authorisations accordingly, wherein the number of authorisations available for an occurrence of the resource 200 will not exceed the number of allocable resource slots that are available.
S8. A number of users wishing to make use of the queue-less access 103 to access a specific occurrence of the resource 200 accept an associated charge and are provided with an authorisation that is valid for that occurrence of the resource 200. If required, information regarding the authorisation can be communicated from the authorisation issuer 106 that issued the authorisation to the authorisation verifier 105 at the queue-less access 103 (either directly or via the resource access manager 107). Alternatively, the system can be configured such that an authorisation issuer 106 can issue authorisations that will be recognised by an authorisation verifier 105 without the need for explicit communication between them. For example, this could be achieved by pre-configuring an authorisation issuer 106 and an authorisation verifier 105 with shared authorisation information from which any issued authorisations are derived and verified.
S9. A user that has a valid authorisation to access a particular occurrence of the resource 200 via the queue-less access 103 can then approach the queue-less access 103 at the time of the occurrence of the resource, and present/provide the associated authorisation verifier 105 with information identifying their authorisation, in accordance with any of the methods described herein. The authorisation verifier 105 will therefore verify a valid authorisation and allow the user to access the resource 200 using the queue-less access 103.

It should be noted that FIG. 2 merely provides an example of the steps that can be performed by the resource access management system in order to manage user access to a resource, and that the management of user access to a resource can comprise fewer steps, alternative steps, or additional steps in accordance with the methods described herein. In particular, it should be noted that not all of these steps are essential according to the methods described herein.

Each component of the resource access management system 100 described herein, including the standard access 101, queue-less access 103, authorisation verifier 105, authorisation issuer 106, resource access manager 107, and standard access queue entrance 108 can be implemented by an appropriate combination of mechanical equipment and computer equipment configured to operate in accordance with the solutions described above. For example, at least the standard access 101, queue-less access 103, and standard access queue entrance 108 can comprise both mechanical equipment such as a gate or turnstile together with computer equipment for implementing monitoring and control in accordance with the methods described above. By way of further example, the authorisation verifier 105, the authorisation issuer 106, and the resource access manager 107 can typically comprise computer equipment configured accordingly. Any computer equipment will comprise appropriately configured computer hardware and software, including but not limited to a processor, a memory, and a transceiver, and may further comprise an interface if required. For example, such an interface could comprise one or more of a graphic user interface, a user input device, a network interface, and a connector/interface for connecting peripherals. Of course, whilst it is preferable that the information/parameters used by the resource access management system 100 described herein are gathered automatically by the system components, it is to be appreciated that the information/parameters could equally be provided/input into the system manually in order to provide manual intervention and/or to provide for redundancy should any of the components be unavailable.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, whilst some of the above embodiments have described the resource access management system 100 with respect to controlling access to a single resource, the resource access management system 100 could equally be configured with a single resource access manager 107 in communication with and controlling access to a number of different resources, each with their own standard access and one or more queue-less access(es). The resource access management system 100 could thereby coordinate the implementation of the access management for all of these resources. Alternatively, the resource access management system 100 for a number of different resources could comprise a plurality of resource access managers 107. In this regard, each of the plurality of resource access managers 107 could be in communication with each other, so as to collectively form a distributed resource access management system, or could also be in communication with a centralised supervising resource access manager that would be configured to coordinate the implementation of the booking system by each of the individual resource access managers.

1. A resource access management system for managing user access to a resource having a number of resource slots, wherein each resource slot can be used by a user, the resource access management system comprising:
a standard access configured to allow users to access the resource;
a standard access queue enclosure through which users must pass to reach the standard access; and
a queue-less access configured to allow users that have a valid authorisation to access the resource;
wherein the resource access management system is configured, for each occurrence of the resource, to make a portion of the resource slots available for allocation to users that access the resource using the queue-less access, to make at least the remaining resource slots available for use by users that access the resource using the standard access, and to ensure that a number of authorisations issued for an occurrence of the resource does not exceed the number of allocable resource slots.

2. The resource access management system of claim 1, wherein the standard access and the queue-less access are configured to transition between a locked and an unlocked state so as to control user to access the resource.

3. The resource access management system of claim 2, wherein the standard access and the queue-less access are configured to allow users to access the resource in a particular order.

4. The resource access management system of claim 2, wherein queue-less access is configured to only allow an authorised user to access an occurrence of the resource.

5. The resource access management system of claim 4, and further comprising:
an authorisation issuer configured to provide a user with an authorisation to access an occurrence of the resource using the queue-less access; and
an authorisation verifier configured to determine if a user has a valid authorisation to access the resource using the queue-less access, and to control the queue-less access accordingly.

6. The resource access management system of claim 1, and further comprising a resource access manager that is communicatively connected to any of the standard access and the queue-less access.

7. The resource access management system of claim 6, wherein the resource access manager is configured to communicate with the authorisation issuer in order to control the issue of authorisations, thereby controlling access to the resource using the queue-less access.

8. The resource access management system of claim 7, wherein the resource access manager is configured to determine a frequency of occurrence of the resource, and to use the determined frequency of occurrence of the resource to determine when authorisations to use the queue-less access should be issued.

9. The resource access management system of claim 8, wherein the resource access manager is configured to instruct the authorisation issuer to only issue authorisations that allow use of the queue-less access at a predicted time of each occurrence of the resource.

10. The resource access management system of claim 6, and further comprising a standard access queue entrance, through which a user must pass in order to enter the standard access queue enclosure.

11. The resource access management system of claim 10, wherein the standard access queue entrance is configured to identify a user that enters the standard access queue enclosure and to notify the resource access manager accordingly, and the standard access is configured to identify a user that exits the standard access queue enclosure and to notify the resource access manager accordingly.

12. The resource access management system of claim 11, wherein the resource access manager is configured to use the notifications received from the standard access queue entrance and the standard access to determine number of users in the standard access queue enclosure and to determine the length of time that each user spends in the standard access queue enclosure.

13. The resource access management system of claim 12, wherein the resource access manager is configured to estimate a waiting time for a user who was to presently enter the standard access queue enclosure based on any of the determined number of users in the standard access queue enclosure and the determined the length of time that each user spends in the standard access queue enclosure.

14. The resource access management system of claim 13, wherein the authorisation issuer is configured to only provide a user with an authorisation to access an occurrence of the resource using the queue-less access upon acceptance of an associated charge.

15. The resource access management system of claim 14, wherein the resource access manager is configured to determine a charge that a user is required to accept in proportion to estimated waiting time for a user who was to presently enter the standard access queue enclosure.

16. A method for managing user access to a resource having a number of resource slots, wherein each resource slot can be used by a user, the method comprising:
for each occurrence of the resource:
making a portion of the resource slots available for allocation to users that access the resource using a queue-less access;
making at least the remaining resource slots available for use by users that access the resource using a standard access, wherein to reach the standard access users must pass through a standard access queue enclosure; and
allowing users to access the resource using the queue-less access provided that they have a valid authorisation, wherein the number of authorisations issued for each occurrence of the resource will not exceed the number of allocable resource slots.

17. The method of claim 16, and further comprising:
determining a frequency of occurrence of the resource, and using the determined frequency of occurrence of the resource to determine when authorisations to use the queue-less access should be issued.

18. The method of claim 17, wherein authorisations are only issued that allow use of the queue-less access at a predicted time of each occurrence of the resource.

19. The method of claim 16, and further comprising:
identifying a user that enters the standard access queue enclosure, identifying a user that exits the standard access queue enclosure, and thereby determining the number of users in the standard access queue enclosure and the length of time that each user spends in the standard access queue enclosure.

20. The method of claim 19, and further comprising
estimating a waiting time for a user who was to presently enter the standard access queue enclosure based on any of the determined number of users in the standard access queue enclosure and the determined the length of time that each user spends in the standard access queue enclosure.

21. The method of claim 20, wherein a user is only provided with an authorisation to access an occurrence of the resource using the queue-less access upon acceptance of an associated charge.

22. The method of claim 21, and further comprising:
determining a charge that a user is required to accept in proportion to the estimated waiting time for a user who was to presently enter the standard access queue enclosure.
